(19) United States
(12) Patent Application Publication
(10) Pub. No.: US 2019/0351349 A1
(43) Pub. Date: Nov. 21, 2019

(54) OIL LEACHING AND EXTRACTION ASSEMBLY CAPABLE OF REPEATED SEPARATION

(71) Applicant: ONGGUAN UNIVERSITY OF TECHNOLOGY, DONGGUAN (CN)

(72) Inventors: CHUAN LI, Dongguan (CN); Haosong Sun, Dongguan (CN); Yun Bai, Dongguan (CN)

(21) Appl. No.: 16/413,732

(22) Filed: May 16, 2019

(30) Foreign Application Priority Data
May 21, 2018 (CN) CN2018104878117

(51) Int. Cl. B01D 11/02; B02C 23/36; B02C 23/10

(52) U.S. Cl. CPC B01D 11/0223; B02C 23/10; B02C 23/36; B01D 11/0296

(57) ABSTRACT

The present invention discloses an oil leaching and extraction assembly capable of repeated separation, which may include an upper rack, a leaching barrel, a separation device, a filter cylinder, a milling device and a material claiming device and a liquid renewal duct and the liquid outlet pipe are respectively provided on the upper and lower part of the leaching barrel. The separation device may include a separation drum and the liquid outlet pipe goes through the separation drum and is connected to an oil tank through the check valve. And a separation hole is provided on the part of liquid outlet pipe locating in the separation drum. For the part where separation drum is under the liquid renewal duct, a electrical heating separation block is provided with. A recycling tank plate whose forms a recycle bin with its left side board is provided on the separation drum. A circulating pump is provided in the recycle in and the circulating pump is connected to the liquid renewal duct. With the design of the liquid outlet pipe going through the separation drum and the electrical heating separation block evaporates the solvents in the liquid outlet pipe from the separation hole and the solvents are collected at the same time. The solvents may flow in the leaching barrel again after the collection process to recycle the solvents. And the circulation flow of the leaching liquid can be heated and separated for several times to ensure the quality of the oil.

### FIELD OF THE INVENTION

The present invention relates to oil extraction facilities, and more particularly to an oil leaching and extraction assembly capable of repeated separation.

### BACKGROUND OF THE INVENTION:

As many crops, such as soybeans, peanuts and tea seeds, contain plenty of oil, they are used to extract oil. The mostly used methods of oil extraction are pressing and leaching. By way of pressing, extracted oil is of good quality so in most circumstances, oil in tea seeds are extracted in this way. By oil leaching method, oil containing elements are submerged in solvent to leach the oil, which can be separated from the solvent by distillation.

When oil pressing is applied, there may be oil residues in the pressed tea seed cakes. In order to improve economic value of crops, in most cases the tea seed cakes will be processed by leaching to extract oil residues. With existing oil leaching process, ground tea seed cakes are put into a solution, soaked for some time, filtered and separated from the solution by distillation. There are some defects to separate oil by distillation, in that in most cases, after separation, certain amount of solution is still left therein, which adversely affects quality of the oil.

### OVERALL OBJECTIVE OF THE INVENTION

The purpose of the present invention is to provide an oil leaching and extraction assembly which is capable of repeated separation. With the structural design of passing the liquid outlet duct through the separation drum, it is possible to separate the solution existing in the liquid outlet duct, collect it and send it back to the leaching drum, achieve circulation of the solution and keep the leaching solution circulating, which can promise oil quality as multiple heating and separation has been done.

### SUMMARY OF THE INVENTION

To achieve the above purpose, this invention adopts the following technical plan: oil leaching and extraction assembly capable of repeated separation includes an upper rack and a lower rack; on the upper rack a leaching barrel and a separation device are provided; wherein a filter drum is provided in the leaching barrel and a milling device is provided on the said filter drum; a material claiming device cooperating with the milling device is provided on the upper rack; a liquid renewal duct and a liquid outlet pipe are respectively provided on the upper and lower end of the leaching barrel; the said separation device may include a separation drum provided on the lower rack; the liquid outlet pipe goes through the separation drum and is connected to the oil tank provided on the lower rack by a check valve; and separation holes are provided on the part of the liquid outlet pipe above the separation drum; an electrical heating separation block is provided under the separation drum below the liquid outlet pipe; on the upper part of the separation drum is provided a recycling tank plate which cooperates with the left side plate of the separation drum to form a recycling tank; a circulating pump is provided in the recycling tank and the circulating pump is connected to the liquid renewal duct.

Furthermore, an electrical heating separation piece is provided under the part of the separation drum located under the recycling tank plate; a recycling blower is provided between the recycling tank plate and right side plate and upper side plate of the separation drum; a cooling and condensing plate cooperating with the recycling blower is provided in the recycling tank and a heat insulation block is provided inside the recycling tank plate.

Furthermore, the milling device may include a milling drum provided on the filter drum; in the middle of the milling drum is connected a milling motor by a milling motor supporting bar; the rotating shaft of the milling motor runs vertically and its upper end is connected to a central milling block, top part of which appears to be a pointed cone; and a lower milling block is provided on the lower end of and surrounding the central milling block; the lower milling block appears to be a coned sleeve which is thicker in the center and thinner in the outer part.

Furthermore, the rotating shaft of the milling motor runs vertically through the milling motor and to the lower end of the rotating shaft is connected a secondary milling block whose lower end appears to be an inverted cone; a ground particle outlet block is provided in the lower part of the milling drum and the ground particle outlet block is provided with an inverted cone shaped opening corresponding to the secondary milling block; the distance between the secondary milling block and the ground particle outlet block gradually decreases from bordering area to the central part, and a ground particle outlet communicating with the filter drum is provided vertically in the center of the ground particle outlet block.

Furthermore, an eccentric milling sleeve is sleeved on the rotating shaft of the milling motor higher than the milling motor; central line of the eccentric milling sleeve is not the same as that of the rotating shaft of the milling motor.

Furthermore, the milling motor supporting bar is connected to the milling motor protective case; the milling motor is fixedly connected in the milling motor protective case; the lower ends of the milling motor protective case are connected to the secondary milling block by the protective casing sealing sleeves provided therein.

Furthermore, in the leaching barrel are provided a first liquid level sensor and a first liquid outlet height of which is the same as that of the lower part of the ground particle outlet block, and a second liquid level sensor and second liquid outlet height of which corresponds to that of the upper end of the milling motor protective case; the first liquid outlet and the second liquid outlet correspond respectively with the first liquid outlet control valve and the second liquid outlet control valve and the first liquid outlet control valve and the second liquid outlet control valve are connected to the liquid outlet pipe through a spillage collection duct.

Furthermore, filter mounting sleeves are provided on the upper ends of the filter drum; the filter mounting sleeves are connected with the milling drums by threads; support plate connecting sleeves are provided on the bottom of the filter drum; the support plate connecting sleeves are connected with the filter support plate by plugging and the filter support plate is solid.

Furthermore, a material loading and stacking device cooperating with the material claiming device is also provided on the lower rack; the material loading and stacking device includes a tea seed cake stacking drum provided on the lower rack and an tea seed cake pushing cylinder running vertically is also provided in the tea seed cake stacking drum; the tea seed cake stacking drum is connected a tea seed cake pushing block cooperating with the tea seed cake; the material claiming device includes a moving material claiming cylinder provided under the upper rack in left and right orientation; the moving material claiming cylinder is connected to a moving material claiming base; below the moving material claiming base, a lifting material claiming cylinder is provided and under the lifting material claiming cylinder is connected a material clamping cylinder which is in right and left orientation and the right, the left ends of the material clamping cylinder are connected the material clamping blocks and on the lower part of the material clamping block to the left side is provide a lower material support.

Furthermore, a milling and crushing cylinder running vertically is provided under the material clamping cylinder and under the milling and crushing cylinder is provided a milling and crushing block (40).

The beneficial effects of the present invention are shown as follows:

With the structure of the liquid outlet duct passing the separation drum, the solvent contained in the liquid outlet duct is evaporated from the separation holes by the electrical heating separation block, then the solvent can be collected and flow into the leaching barrel again to achieve the circulation of the solvent and the leaching liquid can be heated and separated for several times which promises the quality of liquid.

With the structure of the recycling blower and the electrical heating separation piece, the evaporated solvent and a tiny amount of oil may not condense during the rising process and can go back to the recycling tank.

The milling device is simple in structure and convenient in operation, and capable of first grinding the central part of the tea seed cakes and then grinding gradually from bottom of the cakes up and ground particles will fall following the sloping edge of the lower milling block, which is convenient for the ground particle sinking.

With the structure of the secondary milling block and the ground particle outlet block, it is possible to mill the particles of the tea seed cakes for a second time, reducing ground particle size gradually and improving oil extraction efficiency.

With the structure of the eccentric milling block, the remaining parts of the tea seed cakes which are larger than the diameter of the lower milling block can be ground again to further improve efficiency of grinding.

With the structure of the milling motor protective case, the milling motor could be protected, and the leaching liquid may not erode the milling motor.

With the structure of two liquid level sensors and spillage control valves, it is possible not to wet the ground particle outlet block by the leaching liquid during the leaching process to promise natural falling of the ground particles. After completion of the leaching process, the ground particle outlet block could be washed to get rid of any residues and in the meantime prevent the erosion of the milling motor during washing process.

With the structure of the filter mounting sleeves on the upper part of the filter drum and the support plate connecting sleeves on the lower part thereof, disconnection of the filters can be achieved with great ease, and in the meanwhile, when compacting the residues in the filter drum in the subsequent process, it is possible to support from under and material unloading is greatly facilitated.

With the structure of the material loading and stacking device, piles of tea seed cakes could be placed therein and continuous material loading can be achieved in cooperation with the material claiming device to improve overall efficiency.

The material claiming device is simple in structure and easy in operation, design of the lower material support can work with the material clamping blocks to move the tea seed cakes from the top of the tea seed cake stacking drum and support them from under to prevent from falling down.

The structure of the milling and crushing cylinder and the milling and crushing blocks can cooperate with the central milling block to achieve good grinding effect and in the meantime hold the material during material clamping and moving to present tea seed cakes from shaking during material clamping process.

### BRIEF DESCRIPTION OF THE DRAWINGS

FIG. 1 shows the schematic structural diagram of the oil leaching and extraction assembly capable of repeated separation;

FIG. 2 shows the schematic structural diagram of the leaching barrel and milling device;

FIG. 3 shows the schematic structural diagram of the milling device;

FIG. 4 shows the schematic structural diagram of the separation device;

FIG. 5 is an enlarged view of part A in FIG. 4;

FIG. 6 shows the schematic structural diagram of the material loading and stacking device;

FIG. 7 shows the schematic structural diagram of the material claiming device; and

FIG. 8 provides a bottom view that shows the material claiming part.

### REFERENCE NUMBER KEY

All of the various elements in the drawing figures are shown as follows:
1. lower rack
2. upper rack
3. leaching barrel
4. milling device
5. material claiming device
6. material loading and stacking device
7. liquid renewal duct
8. liquid outlet pipe
9. the first spillage control valve
10. the second spillage control valve
11. the first liquid level sensor
12. the second liquid level sensor
14. milling drum
15. filter mounting sleeve
16. filter drum
17. support plate connecting sleeve
18. filter support plate
19. milling motor supporting bar
20. milling motor protective case
21. milling motor
22. protective casing sealing sleeve
23. central milling block
24. lower milling block
25. secondary milling block
26. ground particle outlet block
27. ground particle outlet
28. eccentric milling sleeve
29. tea seed cake
30. tea seed cake stacking drum
31. tea seed cake pushing block
32. tea seed cake pushing cylinder
33. moving material claiming cylinder
34. moving material claiming base
35. lifting material claiming cylinder
36. material clamping cylinder
37. material clamping block
38. lower material support
39. milling and crushing cylinder
40. milling and crushing block
41. separation device
42. spillage collection duct
43. separation drum
44. electrical heating separation block
45. recycling tank plate
46. electrical heating separation piece
47. oil tank
48. check valve
49. separation hole
50. recycling blower
51. cooling and condensing plate
52. circulating pump
53. heat insulation block.

### DETAILED DESCRIPTION OF THE ILLUSTRATED EMBODIMENT

In order to enable a person skilled in the art to better understand the technical scheme of the present invention, the following description may be given to the present invention in detail with reference to the accompanying drawings. The description of the invention is merely exemplary and explanatory and should not limit the scope of the protection scope of the present invention.

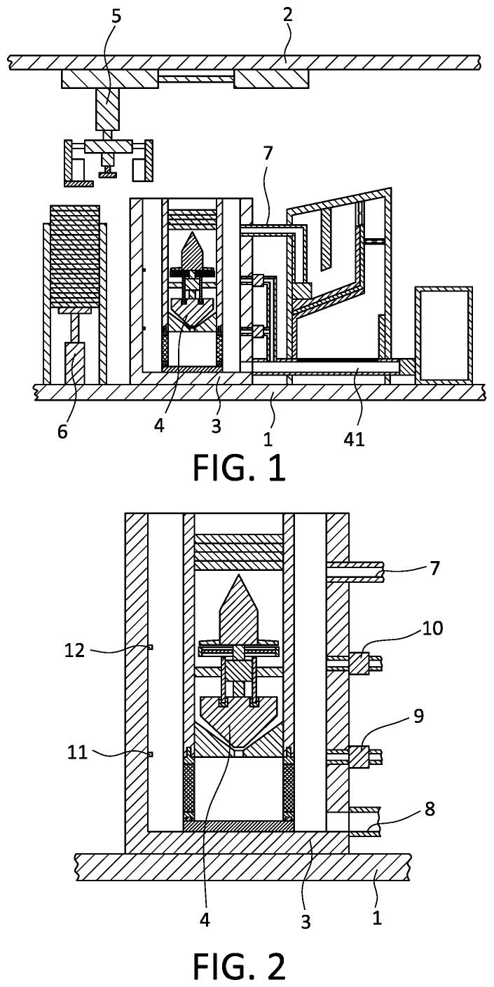

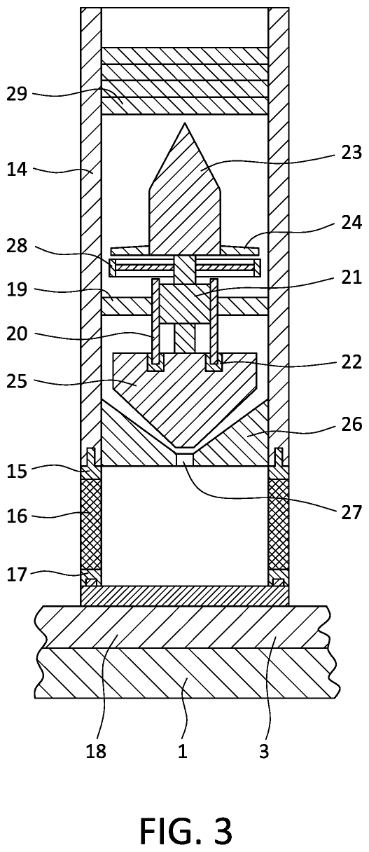

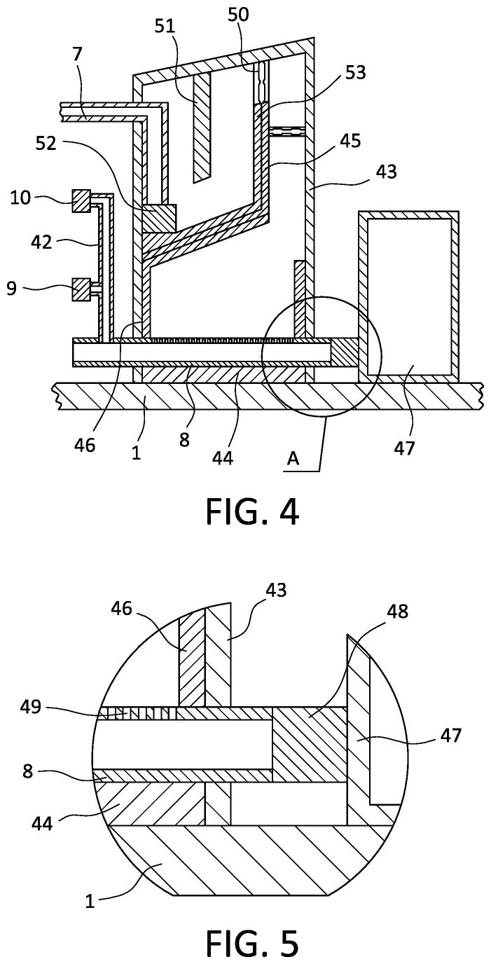

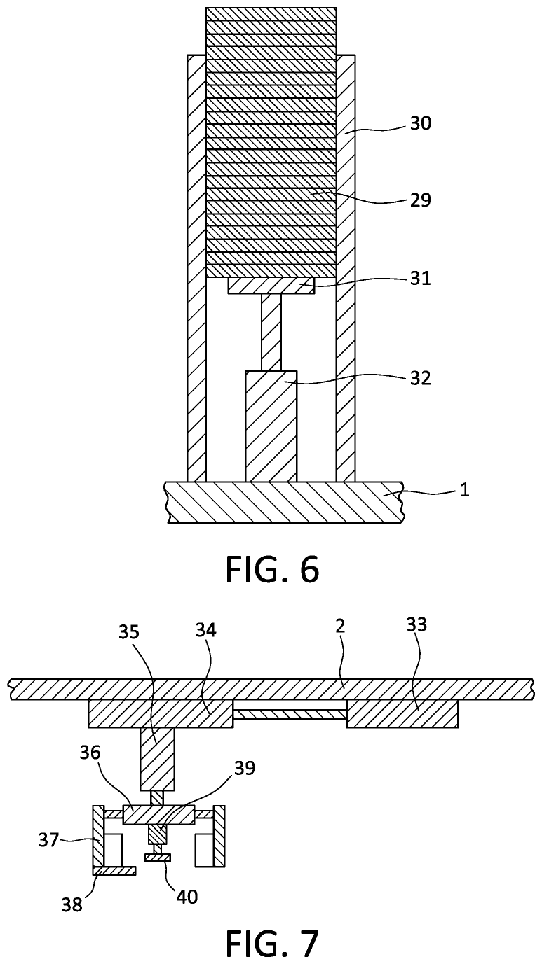

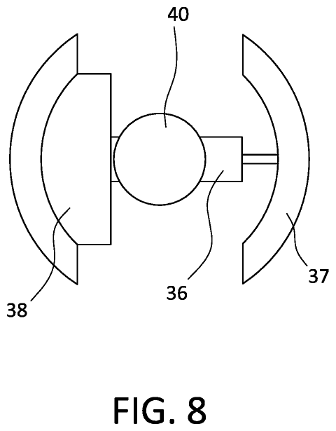

As is shown in FIGS. 1-6, the present invention is shown as follows: the oil leaching and extraction assembly capable of repeated separation includes an upper rack 2 and a lower rack 1; on the upper rack 1 a leaching barrel 3 and a separation device 41 are provided; wherein a filter drum 16 is provided in the leaching barrel 3 and a milling device 4 is provided on the said filter drum 16; a material claiming device 5 cooperating with the milling device 4 is provided on the upper rack 2; a liquid renewal duct 7 and a liquid outlet pipe 8 are respectively provided on the upper and lower end of the leaching barrel 3; the said separation device 41 may include a separation drum 43 provided on the lower rack 1; the liquid outlet pipe 8 goes through the separation drum 43 and is connected to the oil tank 47 provided on the lower rack 1 by a check valve 48; and separation holes 49 are provided on the part of the liquid outlet pipe 8 above the separation drum 43; an electrical heating separation block 44 is provided under the separation drum 43 below the liquid outlet pipe 8; on the upper part of the separation drum 43 is provided a recycling tank plate 45 which cooperates with the left side plate of the separation drum 43 to form a recycling tank; a circulating pump 52 is provided in the recycling tank and the circulating pump 52 is connected to the liquid renewal duct 7.

Preferably, an electrical heating separation piece 46 is provided under the part of the separation drum 43 located under the recycling tank plate 43; a recycling blower 50 is provided between the recycling tank plate 45 and right side plate and upper side plate of the separation drum 43; a cooling and condensing plate 51 cooperating with the recycling blower 50 is provided in the recycling tank and a heat insulation block 53 is provided inside the recycling tank plate 45.

Preferably, the milling device 4 may include a milling drum 14 provided on the filter drum 16; in the middle of the milling drum 14 is connected a milling motor 21 by a milling motor supporting bar 19; the rotating shaft of the milling motor 21 runs vertically and its upper end is connected to a central milling block 23, top part of which appears to be a pointed cone; and a lower milling block 24 is provided on the lower end of and surrounding the central milling block 23; the lower milling block 24 appears to be a coned sleeve which is thicker in the center and thinner in the outer part.

Preferably, the rotating shaft of the milling motor runs vertically through the milling motor 21 and to the lower end of the rotating shaft is connected a secondary milling block 25 whose lower end appears to be an inverted cone; a ground particle outlet block 26 is provided in the lower part of the milling drum 14 and the ground particle outlet block 26 is provided with an inverted cone shaped opening corresponding to the secondary milling block 25; the distance between the secondary milling block 25 and the ground particle outlet block 26 gradually decreases from bordering area to the central part, and a ground particle outlet 27 communicating with the filter drum 16 is provided vertically in the center of the ground particle outlet block 26.

Preferably, an eccentric milling sleeve 28 is sleeved on the rotating shaft of the milling motor 21 higher than the milling motor 21; central line of the eccentric milling sleeve 28 is not the same as that of the rotating shaft of the milling motor 21.

Preferably, the milling motor supporting bar 19 is connected to the milling motor protective case 20; the milling motor is fixedly connected in the milling motor protective case 20; the lower ends of the milling motor protective case 20 are connected to the secondary milling block 25 by the protective casing sealing sleeves 22 provided therein.

Preferably, in the leaching barrel 3 are provided a first liquid level sensor 11 and a first liquid outlet height of which is the same as that of the lower part of the ground particle outlet block, and a second liquid level sensor 12 and second liquid outlet height of which corresponds to that of the upper end of the milling motor protective case; the first liquid outlet and the second liquid outlet correspond respectively with the first liquid outlet control valve 9 and the second liquid outlet control valve 10 and the first liquid outlet control valve 9 and the second liquid outlet control valve 10 are connected to the liquid outlet pipe 8 through a spillage collection duct 42.

Preferably, filter mounting sleeves 15 are provided on the upper ends of the filter drum 16; the filter mounting sleeves 15 are connected with the milling drums 14 by threads; support plate connecting sleeves 17 are provided on the bottom of the filter drum 16; the support plate connecting sleeves 17 are connected with the filter support plate 18 by plugging and the filter support plate 18 is solid.

Preferably, a material loading and stacking device 6 cooperating with the material claiming device is also provided on the lower rack 1; the material loading and stacking device 6 includes a tea seed cake stacking drum 30 provided on the lower rack 1 and an tea seed cake pushing cylinder 22 running vertically is also provided in the tea seed cake stacking drum 30; the tea seed cake stacking drum 32 is connected a tea seed cake pushing block 31 cooperating with the tea seed cake 29; the material claiming device 5 includes a moving material claiming cylinder 33 provided under the upper rack 2 in left and right orientation; the moving material claiming cylinder 33 is connected to a moving material claiming base 34; below the moving material claiming base 34, a lifting material claiming cylinder 35 is provided and under the lifting material claiming cylinder 35 is connected a material clamping cylinder 36 which is in right and left orientation and the right, the left ends of the material clamping cylinder 36 are connected the material clamping blocks 37 and on the lower part of the material clamping block to the left side is provide a lower material support 38.

Preferably, a milling and crushing cylinder 39 running vertically is provided under the material clamping cylinder 36 and under the milling and crushing cylinder 39 is provided a milling and crushing block 40.

During use, first put the tea seed cakes into the tea seed cake stacking drum 30 and install the filter support plate 18. Then the filter drum 16 is connected with the milling drum 14 by the filter mounting sleeves, put the milling device 4 and the filter drum into the leaching barrel, and fill the leaching barrel with leaching solution which shall be lower than that of the first liquid level sensor 11. Then move the moving material claiming base 34 to above the tea seed cake stacking drum 30 with the moving material claiming cylinder 33, and lower the material clamping cylinder 36 to the correct height with the lifting material claiming cylinder 33, thereafter move the material clamping blocks 37 in opposite directions with the material clamping cylinder 36, to have the material clamping blocks 37 move the tea seed cakes above the tea seed cake stacking drum to the lower material support 38 and hold the tea seed cakes in position with the milling and crushing block 40 under the action of the milling and crushing cylinder 39, subsequently activate the moving material claiming cylinder 33 and lifting material claiming cylinder to move the tea seed sakes above the milling drum 14, and open the material clamping blocks to have the tea seed cakes falling into the milling drum 14 and contact the central milling block 23. And the milling and crushing block 40 continues to move the tea seed cakes downwards, and start the milling and crushing motor 21, to grind the central part of the tea seed cakes first and remaining tea seed cakes fall onto the lower milling block 24, with the material claiming device 5 repeating material claiming process, and under the gravity of multiple tea seed cakes, tea seed cakes are ground to pieces and fall off, and cake residues will be ground by the eccentric milling sleeve 28, tea seed cake pieces will slip off from between the ground particle outlet block 26 and secondary milling block 25, during which the secondary milling block 25 grinds the ground particles again, until the particle size is small enough to pass the ground particle outlet 27, fall into the filter drum 16 and mix with the oil leaching solution to leach oil.

During oil leaching, the liquid renewal duct 7 supplies the liquid, and the liquid outlet 8 discharges, when liquid passes the separation drum 43 after entering into the liquid outlet 8, it will be heated by the electrical heat produced by the electrical heating separation block 44 and some solution and a slight amount of oil will be evaporated and gone out via the separation holes 49, and remaining pure oil will pass the check valve 48 and be collected by the oil tank 47. And under the functioning of the two separation blowers, the evaporated oil and some solution will rise to the uppermost of the separation drum and return to the cavity of the recycling tank, and when meeting the cooling and condensing plate, it liquefies, falls into the recycling tank,, and returns to the liquid renewal duct 7 and is sent again to the filter drum, and during separation, the electrical heating separation piece 46 continues to produce heat, to ensure all solution is evaporated and sent to the recycling tank, and multiple separation are done to make sure that there is no leaching solution remaining in the produced oil, and during separation, a dynamic balance is achieved as liquid filling and discharging rate is the same, and at this moment, the first spillage control valve 9 is on, and liquid higher than the first liquid level sensor will pass the first spillage control valve 9 and flow into the leaching solution collection box. After completion of oil leaching process, close the liquid outlet 8 and the first spillage control valve 9 to have the liquid renewal duct 7 fill the liquid, until it reaches the position of the second liquid level sensor 12 and stop filling, keep the second spillage control valve 10 on, and the liquid will clean the side walls and ground particle outlet block 26 to avoid any residues, after which, discharge all liquid from the liquid outlet pipe 8, liquid discharged from both spillage control valves will enter the liquid outlet pipe 8 via the spillage collection duct 42, remove the filter drum 16, and change a new one for subsequent use.

It should be noted that the term “include ” is used herein, “including” or any other variants thereof intended to, encompass a non-exclusive inclusion, such that a process comprising a series of elements is included., the method, the article or the device not only comprise those elements but also include other elements not explicitly listed., or further includes the inherent elements of the process, the method, the article or the equipment.

The principle and the implementation mode of the invention are set forth in the specification. The description of the above examples is only used for helping understand the method of the invention and the core idea of the method. The above descriptions are only preferred embodiments of the present invention and it should be noted that due to the limitation of character expression, an infinite specific structure exists objectively. For persons of ordinary skill in the art, without departing from the principle of the present invention, a plurality of improvements, modifications and changes can be made. The technical features can also be combined in a proper manner. The conception and the technical scheme of the invention can be directly applied to other occasions without improving the conception and the technical scheme of the invention, which can be regarded as the protection scope of the invention.

What is claimed is:

1. The oil leaching and extraction assembly capable of repeated separation includes an upper rack (2) and a lower rack (1); on the upper rack (1) a leaching barrel (3) and a separation device (41) are provided; wherein a filter drum (16) is provided in the leaching barrel (3) and a milling device (4) is provided on the said filter drum (16); a material claiming device (5) cooperating with the milling device (4) is provided on the upper rack (2); a liquid renewal duct (7) and a liquid outlet pipe (8) are respectively provided on the upper and lower end of the leaching barrel (3); the said separation device (41) may include a separation drum (43) provided on the lower rack (1); the liquid outlet pipe (8) goes through the separation drum (43) and is connected to the oil tank (47) provided on the lower rack (1) by a check valve (48); and separation holes (49) are provided on the part of the liquid outlet pipe (8) above the separation drum (43); an electrical heating separation block (44) is provided under the separation drum (43) below the liquid outlet pipe (8); on the upper part of the separation drum (43) is provided a recycling tank plate (45) which cooperates with the left side plate of the separation drum (43) to form a recycling tank; a circulating pump (52) is provided in the recycling tank and the circulating pump (52) is connected to the liquid renewal duct (7).

2. The oil leaching and extraction assembly capable of repeated separation according to the claim 1, characterized in that an electrical heating separation piece (46) is provided under the part of the separation drum (43) located under the recycling tank plate (43); a recycling blower (50) is provided between the recycling tank plate (45) and right side plate and upper side plate of the separation drum (43); a cooling and condensing plate (51) cooperating with the recycling blower (50) is provided in the recycling tank and a heat insulation block (53) is provided inside the recycling tank plate (45).

3. The oil leaching and extraction assembly capable of repeated separation according to the claim 1, characterized in that the milling device (4) may include a milling drum (14) provided on the filter drum (16); in the middle of the milling drum (14) is connected a milling motor (21) by a milling motor supporting bar (19); the rotating shaft of the milling motor (21) runs vertically and its upper end is connected to a central milling block (23), top part of which appears to be a pointed cone; and a lower milling block (24) is provided on the lower end of and surrounding the central milling block (23); the lower milling block (24) appears to be a coned sleeve which is thicker in the center and thinner in the outer part.

4. The oil leaching and extraction assembly capable of repeated separation according to the claim 3, characterized in that the rotating shaft of the milling motor runs vertically through the milling motor (21) and to the lower end of the rotating shaft is connected a secondary milling block (25) whose lower end appears to be an inverted cone; a ground particle outlet block (26) is provided in the lower part of the milling drum (14) and the ground particle outlet block (26) is provided with an inverted cone shaped opening corresponding to the secondary milling block (25); the distance between the secondary milling block (25) and the ground particle outlet block (26) gradually decreases from bordering area to the central part, and a ground particle outlet (27) communicating with the filter drum (16) is provided vertically in the center of the ground particle outlet block (26).

5. The oil leaching and extraction assembly capable of repeated separation according to the claim 4, wherein an eccentric milling sleeve (28) is sleeved on the rotating shaft of the milling motor (21) higher than the milling motor (21); central line of the eccentric milling sleeve (28) is not the same as that of the rotating shaft of the milling motor (21).

6. The oil leaching and, extraction assembly capable of repeated separation according to the claim 4, wherein the milling motor supporting bar (19) is connected to the milling motor protective case (20); the milling motor is fixedly connected in the milling motor protective case (20); the lower ends of the milling motor protective case (20) are connected to the secondary milling block (25) by the protective casing sealing sleeves (22) provided therein.

7. The oil leaching and extraction assembly capable of repeated separation according to the claim 6, wherein in the leaching barrel (3) are provided a first liquid level sensor (11) and a first liquid outlet height of which is the same as that of the lower part of the ground particle outlet block, and a second liquid level sensor (12) and second liquid outlet height of which corresponds to that of the upper end of the milling motor protective case; the first liquid outlet and the second liquid outlet correspond respectively with the first liquid outlet control valve (9) and the second liquid outlet control valve (10) and the first liquid outlet control valve (9) and the second liquid outlet control valve (10) are connected to the liquid outlet pipe (8) through a spillage collection duct (42).

8. The oil leaching and extraction assembly capable of repeated separation according to the claim 3, wherein filter mounting sleeves (15) are provided on the upper ends of the filter drum (16); the filter mounting sleeves (15) are connected with the milling drums (14) by threads; support plate connecting sleeves (17) are provided on the bottom of the filter drum (16); the support plate connecting sleeves (17) are connected with the filter support plate (18) by plugging and the filter support plate (18) is solid.

9. The oil leaching and extraction assembly capable of repeated separation according to the claim 3, wherein a material loading and stacking device (6) cooperating with the material claiming device is also provided on the lower rack (1); the material loading and stacking device (6) includes a tea seed cake stacking drum (30) provided on the lower rack (1) and an tea seed cake pushing cylinder (22) running vertically is also provided in the tea seed cake stacking drum (30); the tea seed cake stacking drum (32) is connected a tea seed cake pushing block (31) cooperating with the tea seed cake (29); the material claiming device (5) includes a moving material claiming cylinder (33) provided under the upper rack (2) in left and right orientation; the moving material claiming cylinder (33) is connected to a moving material claiming base (34); below the moving material claiming base (34), a lifting material claiming cylinder (35) is provided and under the lifting material claiming cylinder (35) is connected a material clamping cylinder (36) which is in right and left orientation and the right, the left ends of the material clamping cylinder (36) are connected the material clamping blocks (37) and on the lower part of the material clamping block to the left side is provide a lower material support (38).

10. The oil leaching and extraction assembly capable of repeated separation according to the claim 9, wherein a milling and crushing cylinder (39) running vertically is provided under the material clamping cylinder (36) and under the milling and crushing cylinder (39) is provided a milling and crushing block (40).
